(19) United States
(12) Patent Application Publication
(10) Pub. No.: US 2019/0134938 A1
(43) Pub. Date: May 9, 2019

(54) Performance Properties Of Pouches For Aseptic Packaging Of Products

(71) Applicant: Liqui-Box Corporation, Richmond, VA (US)

(72) Inventor: Nicholas Farkas, Kingston (CA)

(21) Appl. No.: 16/150,814

(22) Filed: Oct. 3, 2018

Related U.S. Application Data
(60) Provisional application No. 62/567,432, filed on Oct. 3, 2017.
(60) Provisional application No. 62/695,275, filed on Jul. 9, 2018.

(51) Int. Cl. B32B 1/08; B32B 27/08; B32B 27/30; B32B 27/32; B32B 27/34; B29C 65/18; B29C 65/00; B65D 75/48; B65B 51/10; B65B 9/08

(52) U.S. Cl. CPC B32B 1/08; B65B 2220/08; B32B 27/306; B32B 27/32; B32B 27/34; B29C 65/18; B29C 66/43121; B65D 75/48; B65B 51/10; B65B 9/08; B32B 2439/70; B32B 2439/80; B32B 2439/46; B32B 2255/10; B32B 2255/26; B32B 2250/03; B32B 2250/05; B32B 2250/242; B32B 2250/40; B32B 2307/518; B32B 2307/728; B32B 2307/31; B32B 2307/714; B32B 27/08

(57) ABSTRACT

A pouch having improved delamination property and a process for making the pouch includes the steps of (I) providing a film structure and (II) preparing a pouch from said film structure provided in Step (I). The film structure comprises a core layer of at least one biaxially-oriented hygroscopic polymer, and the film structure comprises, on at least one side adjacent to the core layer, an adhesive layer comprising Pacacel™ adhesive.

### CROSS REFERENCE TO RELATED APPLICATIONS

This application claims benefit under 35 U.S.C. § 119(e) of Provisional U.S. Patent Application No. 62/567,432, filed Oct. 3, 2017 and Provisional Patent Application No. 62/695,275, filed Jul. 9, 2018, the contents of which are hereby incorporated by reference in its entirety.

### TECHNICAL FIELD

This invention relates to a process for improving performance properties of pouches made from adhesive laminates for packaging of flowable materials such as coffee concentrate, ice cream mix, and milk shake mix. Preferably, the packaging is aseptic. More specifically, this invention relates to the process of making pouches that provide surprising improvements in delamination of the pouch and in pouch-drop performance.

### BACKGROUND

Pouches are made from laminate films and filled with flowable materials on a vertical, form, fill, seal machine (VFFS). Laminate films, generally comprising polyolefins, for packaging flowable materials, are described in U.S. Pat. Nos. 4,503,102; 4,521,437; 5,206,075; 5,364,486; 5,508,051; 5,721,025; 5,879,768; 5,942,579; 5,972,443; 6,117,4656; 6256,966; 6,406,765; 6,416,833; and 6,767,599. These patents describe polymer blends used to manufacture flexible packages for packaging flowable materials, which includes food packaging. These patents are incorporated herein by reference.

Pouches for packaging flowable materials suffer from two problems: (1) Delamination susceptibility and (2) Pouch-Drop susceptibility.

### Delamination Susceptibility

Pouches are made from adhesive laminate films, generally in a vertical form fill seal (VFFS) machine. Prior to pouch formation and filling with flowable material, the adhesive laminate film undergoes sterilization in a hot-peroxide bath in an aseptic pouch formation. Many times, the aseptic filler machine is shut down unexpectedly for about 60-90 minutes, rendering the adhesive laminate film susceptive to delamination at the adhesive layer-film interface. Similarly, moisture resistance is important because pouches are exposed to ambient humidity during shipping and distribution, and this moisture has been found to cause delamination between the layers of the laminate, causing the filled pouches to leak in the field, and to lose the oxygen barrier properties required for the minimum 6-8 month shelf life.

### Pouch-Drop Susceptibility

Pouches filled with flowable material may leak or burst during transportation, storage, distribution, or use, especially if they are likely to be dropped. Pouches can be dropped and damaged either individually, in a box, or on a pallet. Therefore, improving drop height means that the filled pouches will more likely survive abuse without leaking in the field.

The present invention addresses the above problems of delamination and pouch-drop susceptibility in pouches filled with flowable materials, especially aseptic pouches. The present invention provides a process for preparing pouches and bags that have improved delamination and pouch-drop resistance. The present invention also provides pouches and bags that have improved delamination and pouch-drop resistance. Finally, the present invention also provides adhesive laminates formulation and structure that can be provided for making pouches and bags that have improved delamination and pouch-drop resistance. The present invention thereby provides pouch offering that is more robust and less likely to leak in the field.

### SUMMARY

This invention relates to a process for making a pouch having improved delamination property, said process comprising the following steps: (I) providing a film structure, wherein said film structure comprises a core layer comprising at least one biaxially-oriented hygroscopic polymer, and wherein said film structure comprises, on at least one side adjacent said core layer, an adhesive layer comprising Pacacel™ adhesive; and (II) preparing a pouch from said film structure provided in Step (I).

In one embodiment, this invention relates to a process for making a pouch having improved pouch-drop performance, said process comprising the following steps: (I) providing a film structure, wherein said film structure comprises a core layer comprising at least one biaxially-oriented hygroscopic polymer, and wherein said film structure comprises, on at least one side adjacent said core layer, an adhesive layer comprising Pacacel™ adhesive; and (II) preparing a pouch from said film structure provided in Step (I).

In another embodiment, this invention relates to a process, as recited above, wherein said step (II) comprises the following sub-steps: (A) forming said film structure into a tubular member; (B) heat-sealing the longitudinal edges of said tubular member; (C) filling said tubular member with flowable material; (D) heat-sealing a first transverse end of said tubular member to form a pouch; and (E) sealing and cutting through a second transverse end of said tubular member to provide a filled pouch.

In yet another embodiment, this invention relates to a process, as recited previously, wherein said step (II) comprises the following sub-steps: (A) forming said film structure into a tubular member; (B) heat-sealing the longitudinal edges of said tubular member; (C) filling said tubular member with flowable material; (D) heat-sealing a first transverse end of said tubular member to form a pouch; and (E) sealing and cutting through a second transverse end of said tubular member to provide a filled pouch.

In one embodiment, this invention also relates to a process, as recited above, wherein said at least one bi-axially oriented hygroscopic polymer comprises biaxially-oriented ethylene-vinyl alcohol copolymer or biaxially-oriented polyamide. In another embodiment, this invention relates to a process, as recited above, wherein said film structure comprises at least one skin layer, which is a monolayer or a co-extruded layer. In yet another embodiment, this invention relates to a process, as recited above, wherein said skin layer comprises a polymer blend comprising polyethylene or a polyethylene copolymer. In a further embodiment, this invention relates to a process, as recited above, wherein said polymer blend comprises at least one of LLDPE, ULDPE, EVA, LDPE, HDPE, MDPE, and plastomer. In one more embodiment, this invention relates to a process, as recited previously, wherein said hygroscopic polymer is a biaxially-oriented polyamide, and said at least one skin layer comprises a co-extruded EVOH.

In one aspect, this invention relates to a pouch prepared by any one process recited previously. This invention also relates to a pouch for containing flowable material having improved delamination property, made from a film structure; wherein said film structure comprises a core layer comprising at least one biaxially-oriented hygroscopic polymer; and wherein said film structure comprises, on at least one side adjacent said core layer, an adhesive layer comprising Pacacel™ adhesive.

This invention further relates to a pouch for containing flowable material having improved pouch-drop performance, made from a film structure; wherein said film structure comprises a core layer comprising at least one biaxially-oriented hygroscopic polymer; and wherein said film structure comprises, on at least one side adjacent said core layer, an adhesive layer comprising Pacacel™ adhesive.

This invention, in one embodiment, relates to a pouch, as recited above, wherein said at least one bi-axially oriented hygroscopic polymer comprises biaxially-oriented ethylene-vinyl alcohol copolymer or biaxially-oriented polyamide. In another embodiment, this invention relates to a pouches described previously, wherein said film structure comprises at least one skin layer, which is a monolayer or a co-extruded layer. In yet another aspect, this invention relates to pouches described previously, wherein said skin layer comprises a polymer blend comprising polyethylene or a polyethylene copolymer. In another embodiment, this invention relates to pouches described previously, wherein said polymer blend comprises at least one of LLDPE, ULDPE, EVA, LDPE, HDPE, MDPE, and plastomer. In another embodiment, this invention relates to a pouch described previously, wherein said hygroscopic polymer is a biaxially-oriented polyamide, and said at least one skin layer comprises a co-extruded EVOH. In yet another embodiment, this invention relates to a pouches described previously, comprising flowable material. In a further embodiment, this invention relates to a pouches described previously, wherein said pouch is an aseptic pouch. In one embodiment, this invention relates to a pouches described previously, wherein said pouch is an extended-shelf-life (ESL), hot-fill, or pasteurization pouch.

This invention relates to a bag for containing flowable material having improved delamination property, made from a film structure; wherein said film structure comprises a core layer comprising at least one biaxially-oriented hygroscopic polymer; and wherein said film structure comprises, on at least one side adjacent said core layer, an adhesive layer comprising Pacacel™ adhesive. In yet another embodiment, this invention relates to a bag for containing flowable material having improved pouch-drop performance, made from a film structure; wherein said film structure comprises a core layer comprising at least one biaxially-oriented hygroscopic polymer; and wherein said film structure comprises, on at least one side adjacent said core layer, an adhesive layer comprising Pacacel™ adhesive.

In one aspect, this invention relates to a bag, recited above, wherein said at least one bi-axially oriented hygroscopic polymer comprises biaxially-oriented ethylene-vinyl alcohol copolymer or biaxially-oriented polyamide. In yet another aspect, this invention relates to bags described previously, wherein said film structure comprises at least one skin layer, which is a monolayer or a co-extruded layer. In a further aspect, this invention relates to bags described previously; wherein said skin layer comprises a polymer blend comprising polyethylene or a polyethylene copolymer. In another aspect, this invention relates to bags, wherein said polymer blend comprises at least one of LLDPE, ULDPE, EVA, LDPE, HDPE, MDPE, and plastomer. This invention also relates to bags, wherein said hygroscopic polymer is a biaxially-oriented polyamide, and said at least one skin layer comprises a co-extruded EVOH. In yet another aspect, his invention relates to bags described previously. In yet another aspect, his invention relates to bags described previously, comprising flowable material. In another aspect, this invention relates to bags described previously, wherein said bag is an aseptic bag. In one aspect, this invention relates to a bag, as recited previously, wherein said bag is an ESL, hot-fill, or pasteurization bag.

### BRIEF DESCRIPTION OF THE DRAWINGS

FIG. 1 shows two delaminated aseptic pouches filled with milk;

FIG. 2 shows pouch delamination;

FIG. 3 shows an extreme case of delamination where the skin delaminated on both sides of the core layer;

FIG. 4 shows film delamination from edges going in towards the center of the film;

FIG. 5 shows a schematic of proposed delamination mechanism owing to moisture;

FIG. 6 shows a paired comparison of two samples;

FIG. 7 shows another paired comparison of samples;

FIG. 8 shows a comparison of hedonic acceptability between two samples;

FIG. 9 shows an exemplary taste preparation setup; and

FIG. 10 shows an exemplary tray presentation.

### DETAILED DESCRIPTION OF ILLUSTRATIVE EMBODIMENTS

By flowable materials is meant materials which are flowable under gravity or which may be pumped. Normally such materials are not gaseous. Food products or ingredients in liquid, powder, paste, oils, granular or the like forms, of varying viscosity, are envisaged. Materials used in manufacturing and medicine are also considered to fall within such materials.

### Adhesive Laminate

This invention relates to an adhesive laminate used for making pouches and bags for flexible packaging of flowable materials.

The adhesive laminate of the present invention also known as the film structure comprises a core layer comprising at least one biaxially-oriented hygroscopic polymer; and adhered to the core layer on at least one side adjacent to it, an adhesive layer comprising the Pacacel™ solventless adhesive, which is a two-component polyurethane system comprising the NCO adhesive and the OH coreactant (Pacacel™). The film structure also comprises at least one first skin layer on one side of the core and at least one second skin layer on the other side of the core, with the adhesive layer helping to bond the skin layers with the core layer. This is a five-layer film structure. This invention also encompasses in one embodiment an adhesive laminate that is a seven-layer film structure.

The bi-axially oriented hygroscopic polymer, which forms the core of the adhesive laminate, includes EVOH, EVOH copolymers, Nylon, and Nylon copolymers. These polymers have tendency to absorb moisture, and thus are considered hygroscopic. The core layer can be a monolayer or a co-extruded multilayer, with a thickness ranging from about 5 μm to about 40 μm. Stated another way, the thickness of the core layer can be any one of the following numbers measured in μm, or in a range defined by any two numbers provided below, including the endpoints of such range:
5; 6; 7; 8; 9; 10; 11; 12; 13; 14; 15; 16; 17; 18; 19; 20; 21; 22; 23; 24; 25; 26; 27; 28; 29; 30; 31; 32; 33; 34; 35; 36; 37; 38; 39; and 40.

In one embodiment, the core layer is a biaxially-oriented EVOH in the 12-15 μm range. In another embodiment, the core layer is a biaxially-oriented Nylon in the 8-25 μm thickness.

The Pacacel™ solventless adhesive is coated on one side or both sides of the core layer. If the Pacacel™ solventless adhesive is coated on both sides the thickness (or the coating weight) of the two adhesive layers can be the same or can be different. The coating weight of the adhesive layers ranges from about 0.5 to 5 lbs/ream. Stated another way, the thickness of the adhesive layers can be any one of the following numbers measured in coating weight lbs/ream, or in a range defined by any two numbers provided below, including the endpoints of such range:
0.5; 0.6; 0.7; 0.8; 0.9; 1.0; 1.1; 1.2; 1.3; 1.4; 1.5; 1.6; 1.7; 1.8; 1.9; 2.0; 2.1; 2.2; 2.3; 2.4; 2.5; 2.6; 2.7; 2.8; 2.9; 3.0; 3.1; 3.2; 3.3; 3.4; 3.5; 3.6; 3.7; 3.8; 3.9; 4.0; 4.1; 4.2; 4.3; 4.4; 4.5; 4.6; 4.7; 4.8; 4.9; and 5.0.

If the solventless adhesive Pacacel™ is coated only on one side of the core layer, the other side is coated with an adhesive layer, for example, Mor-Free™

In one embodiment, the skin layers on either side of the adhesive laminate (outer layer and inner layer or sealant layer) form the five-layer structure. The inner skin layer and the outer skin layer can be of different thickness or the same thickness. The skin layer thickness can range from 25 mm to 76 μm. Stated another way, the thickness of the skin layers can be any one of the following numbers measured in μm, or in a range defined by any two numbers provided below, including the endpoints of such range:
25; 26; 27; 28; 29; 30; 31; 32; 33; 34; 35; 36; 37; 38; 39; 40; 41; 42; 43; 44; 45; 46; 47; 48; 49; 50; 51; 52; 53; 54; 55; 56; 57; 58; 59; 60; 61; 62; 63; 64; 65; 66; 67; 68; 69; 70; 71; 72; 73; 74; 75; and 76.

In one embodiment, the overall laminate thickness ranges from 60 μm to 165 μm. Stated another way, the thickness of the adhesive laminate can be any one of the following numbers measured in μm, or in a range defined by any two numbers provided below, including the endpoints of such range:
60; 61; 62; 63; 64; 65; 66; 67; 68; 69; 70; 71; 72; 73; 74; 75; 76; 77; 78; 79; 80; 81; 82; 83; 84; 85; 86; 87; 88; 89; 90; 91; 92; 93; 94; 95; 96; 97; 98; 99; 100; 101; 102; 103; 104; 105; 106; 107; 108; 109; 110; 111; 112; 113; 114; 115; 116; 118; 119; 120; 121; 122; 123; 124; 125; 126; 127; 128; 129; 130; 131; 132; 133; 134; 135; 136; 137; 138; 139; 140; 141; 142; 143; 144; 145; 146; 147; 148; 149; 150; 151; 152; 153; 154; 155; 156; 157; 158; 159; 160; 161; 162; 163; 164; and 165.

The skin layer comprises, generally, polyethylene. It can be a mixture or a blend of linear low-density polyethylene (LLDPE), containing butene, hexene, or octene copolymers.

Optionally, low-density polyethylene (LDPE) can be added at up to 25% by weight of the polymer blend of the skin layer. Stated differently, the weight percent of LDPE in the polymer blend of the skin layer can be any one of the following numbers measured in □, or in a range defined by any two numbers provided below, including the endpoints of such range:
0; 1; 2; 3; 4; 5; 6; 7; 8; 9; 10; 11; 12; 13; 14; 15; 16; 17; 18; 19; 20; 21; 22; 23; 24; and 25.

Optionally, ethylene-vinyl acetate (EVA) can be added up to 100% by weight, that is, the entire skin is made of EVA. Stated differently, the weight percent of EVA in the polymer blend of the skin layer can be any one of the following numbers measured in □, or in a range defined by any two numbers provided below, including the endpoints of such range:
0; 1; 2; 3; 4; 5; 6; 7; 8; 9; 10; 11; 12; 13; 14; 15; 16; 17; 18; 19; 20; 21; 22; 23; 24; 25; 26; 27; 28; 29; 30; 35; 40; 45; 50; 55; 60; 65; 70; 75; 80; 85; 90; 95; 100.

In one embodiment, the vinyl acetate levels in the EVA ranges from 6% to 13.5%.

In one embodiment, the LLDPE, containing hexane and octene-copolymers can comprise of ultra-low-density polyethylene resins (ULDPE), or plastomers, in the density range of 0.86 to 0.94. In other words, the density can be any one of the following numbers measured in g/cm3, or in a range defined by any two numbers provided below, including the endpoints of such range:
0.86; 0.87; 0.88; 0.89; 0.90; 0.91; 0.92; 0.93; and 0.94.

There is extensive description in the art of the types of polymers, interpolymers, copolymers, terpolymers, etc. that may be used in the skin layer of the film structures of the present invention. Examples of patents that describe such polymers include U.S. Pat. Nos. 4,503,102; 4,521,437; and 5,288,531. These patents describe films used to make pouches, which films may also be used to make bags. Other patents references that describe skin layer polymers include U.S. Pat. Nos. 8,211,533; 8,252,397; 8,563,102; 9,757,926; 9,283,736; and 8,978,346.

In one embodiment, the major component of the skin layer comprises one or more polymers selected from ethylene-alpha-olefin interpolymers and ethylene homopolymers, having a density between 0.910 g/cc and 0.935 g/cc. Stated another way, the densities can be any one of the numbers below or a range defined by any two numbers below, including the endpoints:
0.910; 0,911; 0.912; . . . 0.933; 0.934; and 0.935.

There are many examples of suitable polymers, which can be used as this component of the skin layer blend. Suitable ethylene-alpha-olefin interpolymers can be polymerized using Zeigler-Natta catalysts.

Companies such as Dow, Nova, and Huntsman can produce suitable interpolymers commercially (tradenames Dowlex™, Sclair™ and Rexell™, respectively) using a solution phase process; ExxonMobil, ChevronPhillips and Nova can produce suitable interpolymers (tradenames NTX™, MarFlex™ LLDPE, Novapol™ LLDPE respectively) by a gas phase process; ChevronPhillips uses a slurry process (MarFlex™ LLDPE). These polymers can be used in the skin layer.

Suitable ethylene-alpha-olefin interpolymers can also be polymerized using single site catalysts such as ExxonMobil's or ChevronPhillips' metallocene catalysts or Dow's constrained geometry catalysts (tradenames Exceed™, MarFlex mPACT™ and Elite™ respectively). Suitable low-density ethylene homopolymers can be polymerized using the high pressure polymerization process. Commercial examples of such polymers are made by companies such as Nova, Dow, ExxonMobil, ChevronPhillips and Equistar. A Petrothene™ grade from Equistar can also be used. These polymers can be used in the skin layer.

In one embodiment, the skin layer can also comprise another polymeric component: an ethylene C₄-C₁₀-alpha-olefin interpolymer having a density of less than 0.890 g/cc. This polymer is a single-site catalyst or metallocene catalyst polymerization process, but any other interpolymer may be selected for use that has similar characteristics suitable for the film to be produced, may be selected. Typical examples are ethylene-octene interpolymers marketed by Dow under the tradenames Engage™ and Affinity™, and by ExxonMobil under the tradename Exact™. ExxonMobil also manufactures suitable ethylene-hexene and ethylene-butene interpolymers, which are also marketed under the Exact™ tradename. Dow manufactures suitable ethylene-butene interpolymers under the tradename Flexomer™. Alternatives to any of these commercially available products would be selectable by a person skilled in the art for purposes of the invention.

Processing additives are also added to the film formulation described above. They are generally referred to as “masterbatches” and comprise special formulations that can be obtained commercially for various processing purposes. In the present instance, the processing additives are selected from combinations of slip agents, anti-block agents, colorants and processing aids. In the present formulation, the amount of processing additives may range from 0 wt. % to about 20 wt. %. Typical masterbatches may comprise 1-5 weight % erucamide slip agent, 10-50 weight % silica anti-block, 1-5 weight % fluoropolymer process aid, and combinations of two and of three of these additives.

At least one side of the biaxially-oriented EVOH core is coated on or applied to, with an adhesive that is solventless (Pacacel™), as described previously. In some embodiments, more than one adhesive may be used. In such cases, at least one adhesive is the Pacacel™ solventless adhesive described previously.

In embodiments of the adhesive laminate where one adhesive is not the Pacacel™ solventless adhesive, the adhesive used may be an extruded adhesive, another solventless adhesive, a solvent-based adhesive, a 100% solids adhesive or a water-based adhesive. Examples include the broad line of BYNEL™ coextrudable adhesives marketed by E.I. du Pont de Nemours, or the Mor-Free™ adhesive from Dow. Non-polymeric materials can be included in the multi-layer and multi-ply film structures as layers such as, for example aluminum, aluminum oxide or silicon oxide.

In multi-layer polymeric film structure such as the adhesive laminate described above, the layers generally adhere to each other over the entire contact surface, either because the polymer layers inherently stick to each other or because an intermediate layer of a suitable adhesive is used.

As will be understood by those skilled in the art, the multilayer film structure for the pouch of the present invention may contain various combinations of film layers as long as the core layer comprising biaxially-oriented hygroscopic polymer is coated with the Pacacel™ solventless adhesive on at least one side of the core layer forms part of the ultimate film structure.

Many patent references describe the skin layer that can be used in conjunction with the core layer of the adhesive laminate of the present invention: CA 2,113,455; CA 2,165,340; CA 2,239,579; CA 2,231,449 and CA 2,280,910, and U.S. Pat. No. 5,206,075.

In one aspect of the invention, the multilayer film structure for the pouch of the present invention is a coextruded film or a coated film with the core layer comprising bi-axially-oriented EVOH with the Pacacel™ solventless adhesive laminated at least on one side of the core described herein. In one embodiment, the film structure can also include the core layer described previously in combination with a barrier film such as polyester, polyvinylidene dichloride (PVDC) such as SARAN™ (Trademark of The Dow Chemical Company), metallized films, and thin metal foils. The end use for the pouch tends to dictate, in a large degree, the selection of the other material or materials used in combination with the core layer structure.

As discussed previously, hot-peroxide resistance is important because the adhesive laminate or the film structure is subjected to a hot-peroxide bath in the filler, for sterilization purposes, prior to being formed into a pouch and filled. In instances where the aseptic filler is shut down unexpectedly for 60-90 minutes, the adhesive laminate needs to resist delamination, for example, the polyethylene skins peeling away from the biaxially-oriented EVOH core, while remaining exposed in the hot hydrogen peroxide bath. The new adhesive laminate results in higher laminate bond strengths even after peroxide exposure.

Also, moisture resistance is important because pouches are exposed to ambient humidity during shipping and distribution, and this moisture has been found to cause delamination between the layers of the laminate, causing the filled pouches to leak in the field, and also to lose the oxygen barrier properties required for the minimum 6-8 month shelf life. The new adhesive laminate results in pouches that retain laminate bond strength better after prolonged water exposure.

Improved drop height is important because pouches (packaged in boxes) can be dropped—either individually, in the box or on a pallet—and improved drop height means that the filled pouches will more likely survive abuse without leaking in the field. The adhesive laminate of the present invention comprising the new Dow Pacacel™ adhesive technology results in laminate and pouches that are more resistant to hot peroxide and moisture, and increase the pouch drop height performance.

In one embodiment, the adhesive laminate is made up of the following combination:
45-55 μm Skin A print-treated polyethylene skin/Pacacel™ adhesive/10-15 μm biax
EVOH EF-LX core/Pacacel™ adhesive/45-55 μm Skin A print-treated polyethylene skin.

This adhesive laminate is symmetrical. The adhesive is Dow Pacacel™ L75-191 isocyanate and CR88-141 polyol.

This adhesive laminate can be used for aseptic VFFS pouches. This technology can also be used for hot-fill, extended shelf-life, or other pouch applications that are not necessarily aseptic. In one embodiment, the adhesive laminate based on a biaxially-oriented-EVOH core, the laminate skins can have various thicknesses and resin compositions. Note that the skin A are the print-treated skins on the laminate that comprises a biaxially-oriented EVOH core.

The Skin A comprise the following:
76.2% Nova Sclair® FP020D octene-LLDPE resin (0.92 density, 0.7 melt-index (MI))
13.0% Chevron 4517 LDPE (0.923 density, 5.1 MI)
10% Nova Surpass® FPs-117 (0.917 density, 1.0 MI)
0.8% antiblock masterbatch

### Pouch

In one embodiment, this invention also relates to pouches for packaging flowable materials are made from adhesive laminates or film structures described previously. The pouches manufactured using the film of the invention may range in size from generally 200 ml to 10 liters. Stated another way the pouch sizes could be any number given below in ml, or within the range defined by any numbers given below, including the end-points:
20; 40; 60; 80; 100; 120; 140; 160; 180; 200; 400; 600; 800; 1000; 1,200; 1,400; 1,600; 2,000; 2,200; 2,400; 2,600; 2,800; 3,000; 3,200; 3,400; 3,600; 3,800; 4,000; 4,200; 4,400; 4,600; 4,800; 5,000; 5,200; 5,400; 5,600; 5,800; 6,000; 6,200; 6,400; 6,600; 6,800; 7,000; 7,200; 7,400; 7,600; 7,800; 8,000; 8,200; 8,400; 8600; 8,800; 9,000; 9,200; 9,400; 9,600; 9,800; and 10,000.

In one embodiment, pouch sizes can vary from about 1 liter to 2.5 liters in size.

The pouches of the present invention can also be printed by using techniques known in the art, e.g., use of corona treatment before printing.

The pouches described herein will refer to core layer used in the film structure of the pouch described in the previous section.

Pouches Filled with Flowable Materials

In one aspect, this invention also relates to pouches described above, filled with flowable materials. In another aspect, this invention relates to liquids-from very low viscosity liquids to very viscous liquids, consumable, household, commercial, and industrial fluids. Examples include pouches filled with flowable materials such as water, beverages, juices, coffee, tea, energy drinks, beer, wine, sauces, mustard, ketchup, food dressings, milk, cheese, sour-cream, mayonnaise, salad dressings, relish, oils, soft margarine, coffee concentrate, pastes, puree, ice cream mix, milk shake mix, preserves, emulsions, doughnut fillings, jellies, detergents, cleaners, liquid soaps, chemical fluids such as motor oils, floor waxes, caulking materials, medicines, materials used in manufacturing, and the like.

### Pouch-Making Process

Pouches are made using the vertical form-fill-seal machine (VFFS) or the horizontal form-fill-seal machine (HFFS). The VFFS and HFFS machines are well known in the art. The film structure once made can be cut to a desired width for use on the machine. A pouch generally comprises a tubular shape having a longitudinal lap seal or fin seal with transverse end seal, such that, a “pillow-shaped” pouch is formed when the pouch is manufactured and contains flowable material.

The films of the invention may be produced by any suitable method for producing polyethylene film. Multi-layer films can be blown or cast extrusions, thermal laminates or adhesive laminates.

Such pouches are described in patents CA 2,182,524 and CA 2,151,589. These patents also describe pouch making using VFFS machines and processes. The disclosures of all of these patents are incorporated herein by reference.

In one embodiment, this invention relates to a process for making a pouch having improved delamination property and/or an improved pouch-drop performance, said process comprising the steps (I) providing a film structure described previously, wherein said film structure comprises a core layer comprising at least one biaxially-oriented hygroscopic polymer, and wherein said film structure comprises, on at least one side adjacent said core layer, an adhesive layer comprising Pacacel™ adhesive; and (II) preparing a pouch from said film structure provided in Step (I).

In another embodiment, this invention relates to a process, as recited above, wherein said step (II) comprises the sub-steps, (A) forming said film structure into a tubular member; (B) heat-sealing the longitudinal edges of said tubular member; (C) filling said tubular member with flowable material; (D) heat-sealing a first transverse end of said tubular member to form a pouch; and (E) sealing and cutting through a second transverse end of said tubular member to provide a filled pouch.

### Bag

The bags may range in size from 2 liters to over 300 gallons (1,200 liters). For example, the bags may range in size given by any number given below in L, or within the range defined by any two numbers given below, including the end-points:
2, 3, 4, 5, 6, 7, 8, 9, 10, 15, 20, 25, 30, 40, 50, 60, 70, 80, 90, 100, 150, 250, 300, 350, 400, 450, 500, 550, 600, 650, 700, 750, 800, 850, 900, 950, 1000, 1050, 1100, 1150, and 1200.

Bags can be single-ply, or multi-ply. Inner plies of multi-ply bags, which are added to improve shipping and handling performance, are normally mono-films. Multi-layer films are used to make pouches or bags, which need a more sophisticated combination of properties, for example, higher barrier to oxygen. The outer ply of a multi-ply bag is often a multi-layer film. The middle ply may also be a multi-layer film, and is often of different composition than the outer ply. In one embodiment of the present invention, where a multi-layer film structure is used, the multi-layer film structure necessarily comprises the biaxially-oriented EVOH core layer with the Pacacel™ adhesive at least on one side of said core layer.

In one embodiment, the various plies in a multi-ply bag do not adhere to each other except at the edges of the bag in the heat seals. In another main aspect, the invention provides a multi-ply bag, used for packaging flowable material, which has an outer multi-layer film ply that has the biaxially-oriented EVOH core layer with the Pacacel™ adhesive at least on one side of said core layer, and having a thickness of from about 2 to about 50 mm.

The bags are pre-made and then usually filled through a fitment. They are often radiation sterilized in a batch process by the bag manufacturer. The packaging conditions may include those for aseptic packaging.

Bags Filled with Flowable Materials

In one aspect, this invention also relates to bags described above, filled with flowable materials. Examples include bags filled with flowable materials such as water, beverages, juices, coffee, tea, energy drinks, beer, wine, sauces, mustard, ketchup, food dressings, milk, cheese, sour-cream, mayonnaise, salad dressings, relish, oils, soft margarine, coffee concentrate, pastes, puree, ice cream mix, milk shake mix, preserves, emulsions, doughnut fillings, jellies, detergents, caulking materials, medicines, materials used in manufacturing, and the like.

In one embodiment, this invention relates to an adhesive laminate film described previously, the process of making such film, the pouches made from such film, the process of making such pouches, the process of filling such pouches with flowable material, and the pouches filled with such flowable materials, wherein the pouches are aseptic pouches. In another embodiment, such pouches contain coffee mix, ice cream mix, etc. In one embodiment, the Prepac 2000 and 4000 fillers, and the AS-3 and AS-6 VFFS fillers are used to make these aseptic pouches. In one embodiment, the sizes of aseptic pouches made as such can vary from about 1 liter to 2.5 liters.

### EXPERIMENTAL

### Example 1

### Improvement in Delamination Susceptibility

This example showed improvement in resistance to hot peroxide exposure and to ambient moisture for adhesive laminates used for preparing pouches and bags. Two adhesive laminates were made using biaxially-oriented EVOH core. The first laminate, or the comparative sample, was made using the Mor-Free™ adhesive. The second laminate, that of the invention, was made using the Pacacel™ adhesive.

### First Laminate Comparative

In preparing the first laminate (the comparative example), the biaxially-oriented core was laminated on both sides with Mor-Free™ adhesive from Rohm & Haas (Dow). Nord-Meccanica Super Combi 3000 laminator was used for making this lamination. A skin layer was added to both sides of the adhesive lamination. Each skin layer was adhered to the biaxially-oriented EVOH core in a separate pass of the extrusion.

In the first pass, the cap layer or the outside polyethylene layer was adhered. This was accomplished at the rate of 700 feet per minute (fpm). As to the adhesive coating weight, 1.1-1.2 lbs/ream was used. The biaxially-oriented EVOH core was subjected to bump corona treatment at 3.65 KW output on a 119-cm wide film that was 12 mm thick. The cap layer or the outside polyethylene skin layer was also bump corona treated at 2.64 KW output for a 51 mm thick film.

In the second pass, the sealant layer or the inside polyethylene layer was adhered. This was accomplished at the rate of 700 fpm. As to the adhesive coating weight, 1.1-1.2 lbs/ream was used. The biaxially-oriented EVOH core was subjected to bump corona treatment at 3.16 KW output on a 119-cm wide film that was 12 mm thick. The sealant layer or the inside polyethylene skin layer was also bump corona treated at 2.34 KW output for a 51 mm thick film.

### Second Laminate—Invention

In preparing the second laminate (the invention example), the biaxially-oriented core was laminated on both sides with Pacacel™ adhesive from Dow. Nord-Meccanica Super Combi 3000 laminator was used for making this lamination. A skin layer was added to both sides of the adhesive lamination. Each skin layer was adhered to the biaxially-oriented EVOH core in a separate pass of the extrusion.

In the first pass, the cap layer or the outside polyethylene layer was adhered. This was accomplished at the rate of 700 fpm. As to the adhesive coating weight, 1.1-1.2 lbs/ream was used. The biaxially-oriented EVOH core was subjected to bump corona treatment at 3.65 KW output on a 119-cm wide film that was 12 mm thick. The cap layer or the outside polyethylene skin layer was also bump corona treated at 2.64 KW output for a 51 mm thick film.

In the second pass, the sealant layer or the inside polyethylene layer was adhered. This was accomplished at the rate of 700 fpm. As to the adhesive coating weight, 1.1-1.2 lbs/ream was used. The biaxially-oriented EVOH core was subjected to bump corona treatment at 3.16 KW output on a 119-cm wide film that was 12 mm thick. The sealant layer or the inside polyethylene skin layer was also bump corona treated at 2.34 KW output for a 51 mm thick film.

All laminates—comparative and invention—were then subjected to either hot-peroxide treatment or to ambient moisture. The peroxide bath contained 35% peroxide at 50-60° C. In Table 1 below, laminate bond strengths are provided for the comparative laminate and the invention laminate.

TABLE 1
Comparative Bond Strengths of the Inventive Laminate and the
Comparative Laminate

| | | Laminates | | | |
|---|---|---|---|---|---|
| | | Comparative Laminate | | Inventive Laminate | |
| | | Bond Strength in (g/in) | | Bond Strength in (g/in) | |
| | | | Second Pass | | Second Pass |
| Test | | First Pass | (Sealant | First Pass | (Sealant |
| No. | Test Conditions | (Cap Layer) | Layer) | (Cap Layer) | Layer) |
| 1. | Hot peroxide treatment at | 1061 | 1061 | 967 | 948 |
| | 50° C. for one hour (July) | | | | |
| 2. | Hot peroxide treatment at | 481 | 886 | 866 | 792 |
| | 60° C. for 1.5 hours (August) | | | | |
| 3. | Water immersion for 7 days | 457 | 456 | 766 | 627 |
| | (July) | | | | |
| 4. | Water immersion for 7 days | 349 | 539 | 682 | 562 |
| | (August) | | | | |
| 5. | Water immersion for 24 | 593 | 878 | 975 | 855 |
| | hours (current) | | | | |

We have made the following observations of surprising results of the IL over the CL, in terms of their bond strengths, measured in Win, from the above Table 1.

In the first test, the Comparative Laminate (CL) and the Inventive Laminate (IL) were treated with hot peroxide at 50° C. for one hour. In the second test, the hot-peroxide exposure was increased to 60° C. and the exposure time was increased by 30 minutes. The IL showed the First Pass bond strength reduction by only 10.4%, while the CL showed the First Pass bond strength reduction by 55%. In direct comparison, the First Pass bond strength of the IL was 45% higher than the CL.

In the third test, that is the 7-day water immersion test, the First Pass bond strength of the IL improved by 68% over the First Pass bond strength of the CL; the Second Pass bond strength of the IL was improved by about 38% over the Second Pass bond strength of the CL.

In the fourth test, that is a second 7-day immersion test, the First Pass bond strength of the IL improved by about 95% over the First Pass bond strength of the CL; and the Second Pass bond strength of the IL was within 5% of the Second Pass bond strength of the CL.

In the fifth test, that is, the 24-hour water immersion test, the First Pass bond strength of the IL improved by about 64% over the First Pass bond strength of the CL and the Second Pass bond strength of the IL was within 5% of the Second Pass bond strength of the CL.

### Example 2

### Improvement in Pouch-Drop Susceptibility

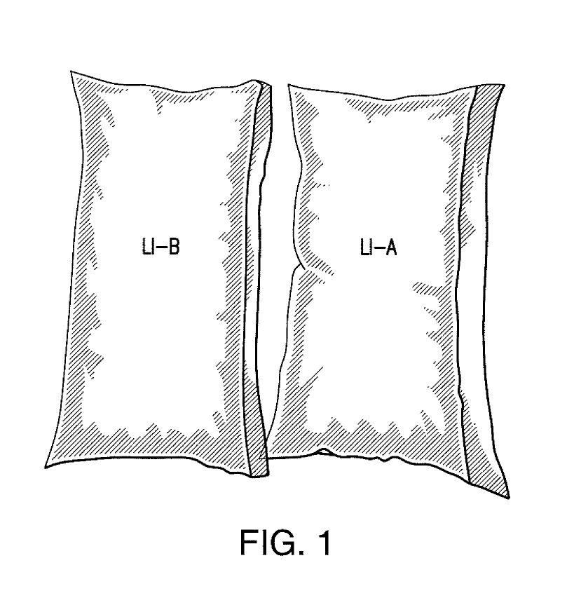

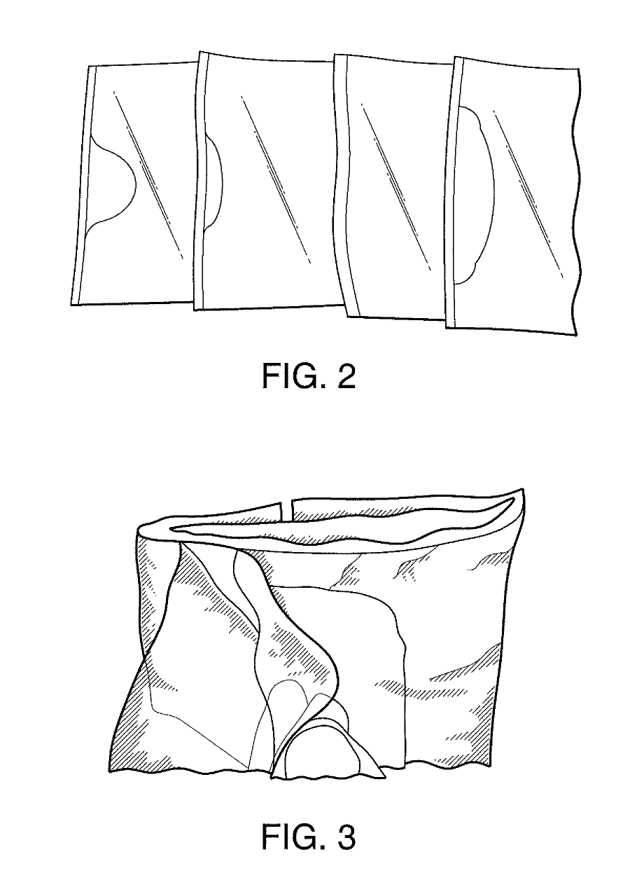

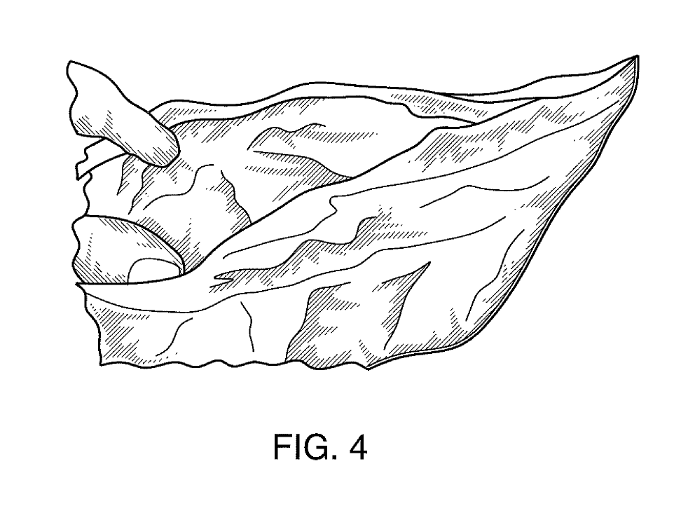

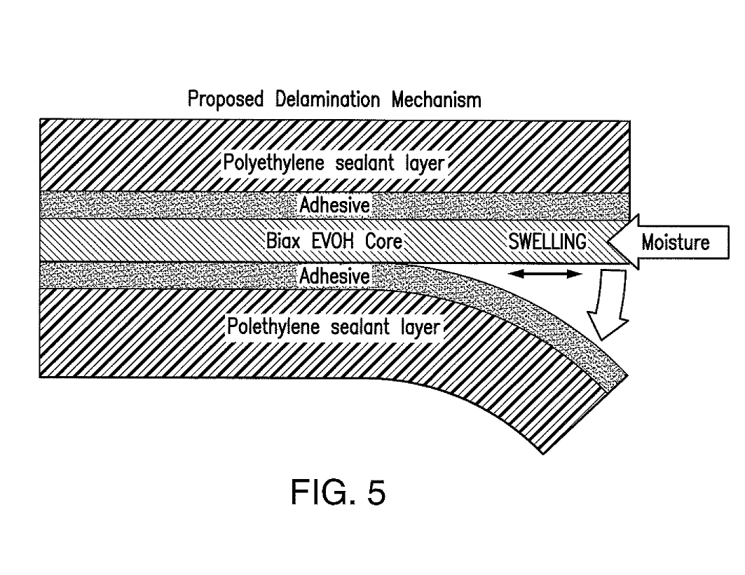

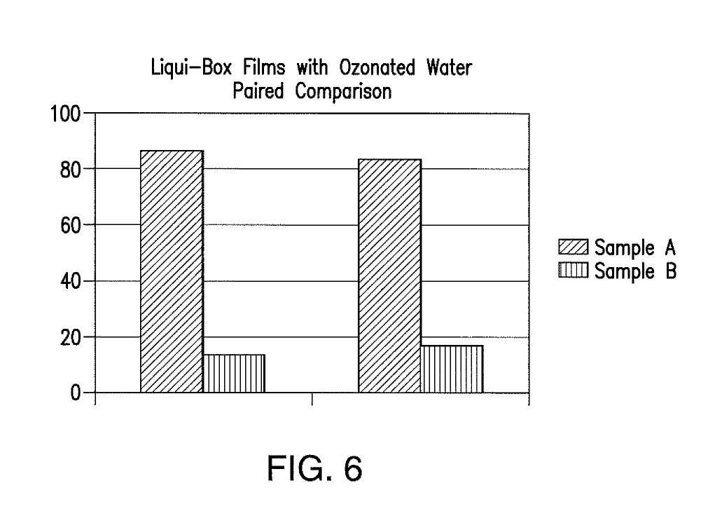

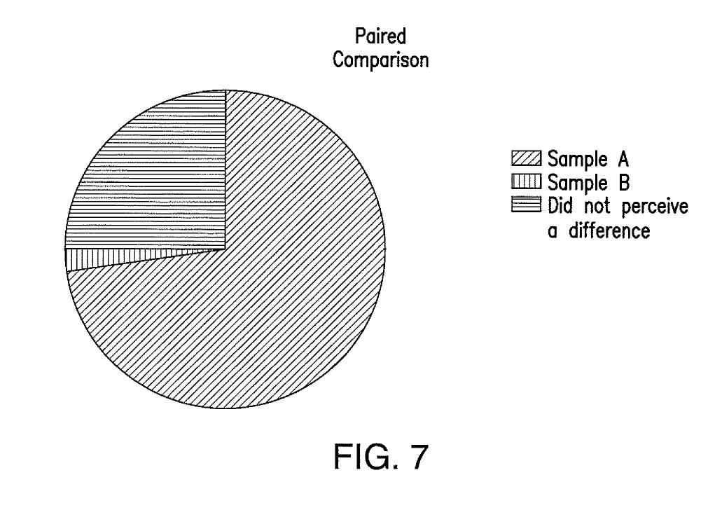

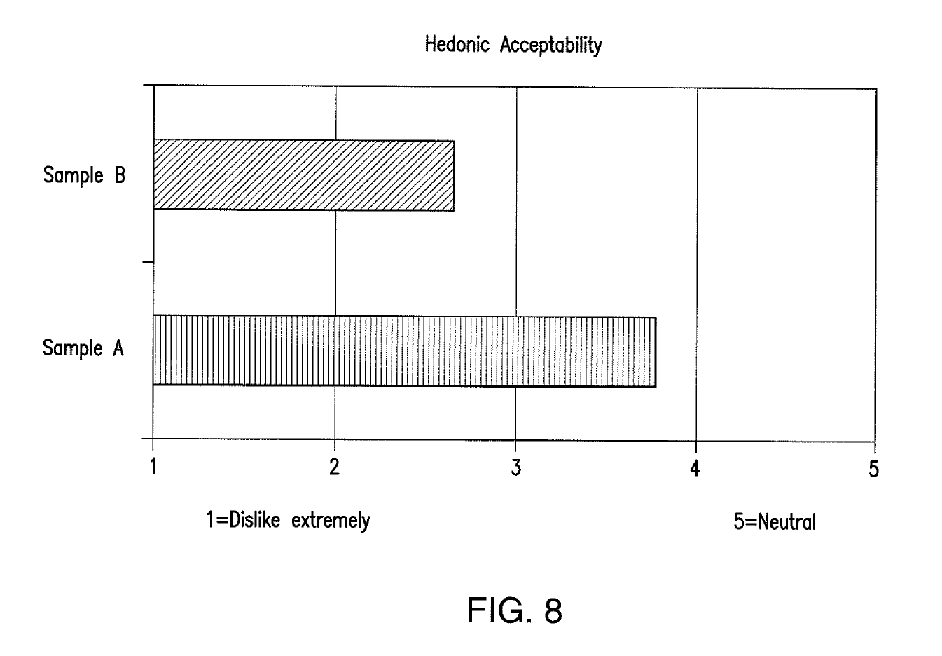

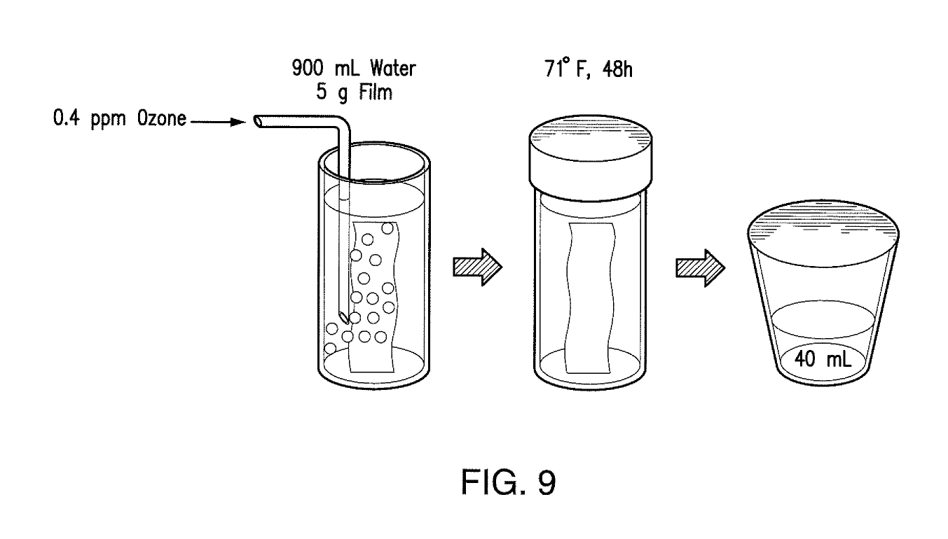

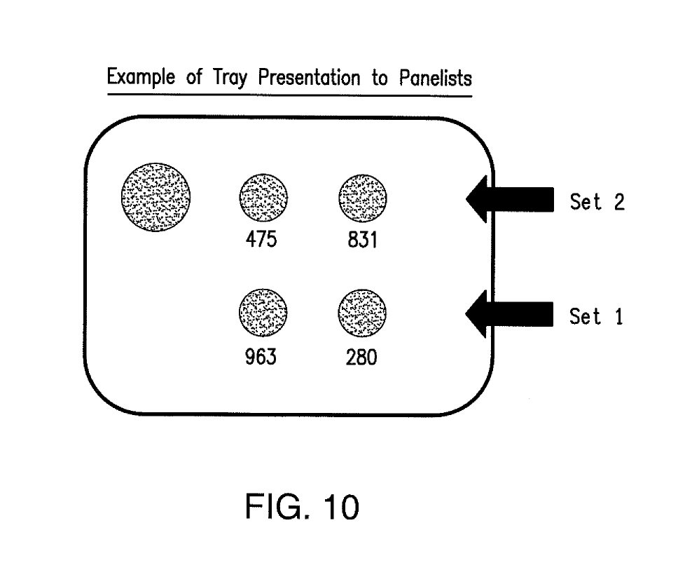

The adhesive laminates described in Example 1, that is, the Comparative Laminate and the Inventive Laminate were made into pouches on a Prepac AS-3 VFFS filler. The clear pouch shown in the picture of FIG. 1 is what was tested. The filler run conditions were the same for all pouches made.

In the first test, 50 pouches made from Comparative Laminate (CL) were dropped flat, and not on their edges, from a height of 8 feet onto a flat Plexiglas® plate. The percentage of pouches that leaked was noted. In all, 26% (13 out of 50) of the pouches leaked, a very high number. In the second test, 50 pouches made from the Inventive Laminate (IL) were also dropped from 8 feet (flat, and not on edges). None of the IL pouches leaked. In the third test, 50 IL pouches were dropped from a height of 10 feet. Even with a 25% increased height, only 4% (2 out of 50) of the IL pouches leaked. Stated differently, the IL pouches, even with an extra two feet of drop height, showed a surprising improvement in pouch drop performance by about 85%—a saving of 22 bags out of every 100 bags dropped, and that as well from a 25% higher elevation. For an equal height drop, in the IL pouches, virtually all likelihood of leaks was eliminated—that is saving of 26 bags out of every 100 bags dropped in similar circumstances, of 8-feet height. This shows that the pouches made with the new adhesive result in a tougher film and seals, giving higher drop heights.

TABLE 2
Pouch-Drop Performance--Comparative
Pouches and Inventive Pouches

| | | | | | | % at | |
|---|---|---|---|---|---|---|---|
| | | | | | | Ver- | |
| | | Drop | | % | % | tical | |
| Test | Pouch | Height | Total % | Hori- | Ver- | Over- | % Film |
| No. | Type | (Feet) | Leakers | zontal | tical | lap | Pinhole |
| 1. | Comparative | 8 | 26 | 14 | 6 | 6 | 0 |
| | Laminate | | | | | | |
| | Pouch | | | | | | |
| 2. | Inventive | 8 | 0 | 0 | 0 | 0 | 0 |
| | Laminate | | | | | | |
| | Pouch | | | | | | |
| 3. | Inventive | 10 | 4 | 0 | 4 | 0 | 0 |
| | Laminate | | | | | | |
| | Pouch | | | | | | |

### Example 3

### Human Panel to Determine Differences in Taste of Water in Bags of Two Film Samples A and B

A human sensory panel was used to determine differences in taste to ozonated water in bags of two different blown film Samples A and B. The panel is a trained panel and is comprised of in-house employees that have been screened to determine their taste and odor capability. Approximately 30% of the population has the capability required to participate on such a panel to determine differences between samples at very low concentration levels. The panelists are trained to characterize the types of tastes and odors associated with Polyolefin products for descriptive analysis.

Film Samples A and B were prepared. Each of the Samples A and B having a 3 layered structure prepared from blown films that comprised (1) 60% by weight of a core layer and (2) 20% by weight of an outer skin layer on each side of the core. Both the core layer and the skin layers of Film Samples A and B are formed of the following polymer blend of 70% Dowlex™ 2045 (0.92 g/cc, 1MI) LLDPE and 30% of a LDPE (MI,1). Film Sample A contained 3% by weight of a silicone master batch in the outer skin to modify the coefficient of friction and Film Sample B contained 700 ppm erucamide, anti-blocking agent in the outer skin to modify the coefficient of friction.

The following tests were used to determine water taste differences between the bags of film samples A and B: the Paired Comparison, Intensity Ranking and Hedonic Acceptability tests. In the Paired Comparison and Intensity ranking tests, Sample A was determined to be statistically less intense (better) than Sample B. In the Hedonic Acceptability test, Sample A was determined to have a significantly more acceptable taste than Sample B. Sample A was rated in the ‘dislike moderately’ category and Sample B was rated in the ‘dislike very much’ category. Both Samples A and B were primarily described as tasting ‘Bitter’ and ‘Polymer’. Sample A had more ‘No taste’ characteristics whereas Sample B had more ‘Offensive’ and ‘Chemical’ characteristics.

In the Paired Comparison test, panelist members are asked to select which of the two samples has the least intense (better) taste/odor. This method determines if there is a difference between two samples, and if so, which one is better. Two sets of samples are evaluated to provide a measure of test reproducibility.

The Paired Comparison method is traditionally regarded as the most straight forward difference test. Panelists are asked to select which of the two samples has the least intense (better) taste/odor. This method determines if there is a difference between two samples, and if so, which one is better. Two sets of samples are evaluated to provide a measure of test reproducibility.

TABLE 3
Paired Comparison Test

| | | | | |
|---|---|---|---|---|
| Set 1: | 25 (86%) | (14%) | 29 | 0.1% significant difference |
| Selected as | | | | |
| least intense | | | | |
| Set 2: | 24 (83%) | 5 (17%) | 29 | 0.1% significant difference |
| Selected as | | | | |
| least intense | | | | |
| Replication: | 21 (72%) | 1 (3%) | 29 | 22 of 29 panelists replicated |
| Selected as | | | | data - indicates 1% significant |
| least intense | | | | difference |
| in both sets | | | | |

The Hedonic Rating Method provides the ‘degree of liking’ of the samples. This determines how acceptable humans find the samples. Higher numbers indicate more favorable/better values.

The alpha characters next to the mean values indicate differences. Letters that are different indicate that the samples are statistically different. Letters that are the same indicate that there is no statistical difference.

TABLE 3.1
Numeric Range for “degree of Liking’

| 1 | 2 | 3 | 4 | 5 | 6 | 7 | 8 | 9 |
|---|---|---|---|---|---|---|---|---|
| Dislike | Dislike | Dislike | Dislike | Neither | Like | Like | Like very | Like |
| extremely | very | moderately | slightly | like or | slighly | moderately | much | extremely |
| | much | | | dislike | | | | |

Note:
Nestle Pure Life purified water has a rating of 4.89 on the Hedonic Acceptability Taste Scale.

TABLE 4
Hedonic Acceptability

| Sample | Taste Contribution to Water w/Film |
|---|---|
| Sample A | 3.79a |
| Sample B | 2.66b |

Panelists were directed to document all descriptive terms that characterize the sample. The numbers indicate the number of panelists that used the term to characterize the products.

TABLE 5
Organoleptic Characteristics

| Characteristic | Sample A | Sample B |
|---|---|---|
| Bitter | 9 | 7 |
| Plastic/Polymer | 7 | 10 |
| No taste | 4 | 0 |
| Dry/Astringent | 3 | 3 |
| Waxy | 3 | 3 |
| Dirt/Earthy | 1 | 2 |
| Metallic | 1 | 1 |
| Medicinal | 1 | 1 |
| Musty | 1 | 1 |
| Feet | 1 | 0 |
| Fruity | 1 | 0 |
| Gasoline | 1 | 0 |
| Stale | 1 | 0 |
| Offensive | 0 | 3 |
| Chemical--Aldehyde/Ketone | 0 | 3 |
| Woody | 0 | 2 |
| Chalky | 0 | 1 |
| Citrus | 0 | 1 |
| Oxidized | 0 | 1 |
| Pencil shavings | 0 | 1 |
| Spicy | 0 | 1 |
| Sweet | 0 | 1 |

A two-tailed binomial statistical table was used with the paired comparison data to determine if there were any significant differences among the samples. Two-tailed is used when it is not known which sample has greater amount of the attribute being judged.

TABLE 6
Two-tailed Binomial Statistical Table

| Number of test | Minimum of correct/incorrect | | | |
|---|---|---|---|---|
| subjects or | judgments for a level of error of | | | |
| panelists | α = 0.10 | α = 0.05 | α = 0.01 | α = 0.001 |
| 29 | 20 | 21 | 22 | 24 |
| | Slight | Significant | Highly | Very Highly |
| | Significance | | Significant | Significant |

α is called ‘level of error’ (the unjustified rejection of the null hypothesis). Example: α=0.05 is a significance of 5% which is the same as a confidence of 95%.

An F-statistic in Analysis of Variance (ANOVA) was used with the hedonic rating data to determine if there were any significant differences among the samples in the multiple comparisons. The F-ratio in the ANOVA indicated samples to be significantly different, so a Fisher's Least Significant Difference (LSD) was calculated to determine One-at-a-Time multiple comparisons. The Fisher's LSD test is used for pairwise comparisons when a significant F-value has been obtained.

TABLE 7
Statistical Significance Data

| | | Confidence Level | |
|---|---|---|---|
| | | that the result | |
| Level of | Statistical | is not based | |
| Error α | Significance Level | solely on chance | Result |
| 0.10 | 10% | 90% | Low Signifcance |
| 0.05 | 5% | 95% | Significant |
| 0.01 | 0.1% | 99% | High Significance |
| 0.001 | 0.01% | 99.9% | Very High |
| | | | Significance |

For taste preparation, 5 g of film was immersed in 900 mL of Nestle Purified drinking water in a glass jar secured with a PTFE lined lid. Each 5-g bubble of film was 5 inches by 15.5 inches. The water was then ozonated to a level of 0.4 ppm. The samples were stored at room temperature for 48 hours. The film was then removed and the water was poured into a large glass container to make a homogenous mix. For the evaluation, 40 mL was poured into 7 oz. PS cups and served at room temperature.

TABLE 8
Taste Preparation

| | |
|---|---|
| Test Medium | Nestle Pure Life purified water (900 ml) |
| Sample | Unblocked, Blown Film (5 g; 5 in × 15.5 in) |
| Ozonation Level | 810 mV (0.4 ppm) |
| Contact Time | 48 hours |
| Contact Temperature | Room temperature |
| Serving Temperature | Room temperature |
| Serving Amount | 40 mL in 7 oz cup |

Panelists used water between taste samples to reduce fatigue and carry-over effect. Random three-digit codes were used as blind sample identification. A balanced block design was used to ensure all samples were served equally often and in all positions. The replicate set of samples provided a measure of test reproducibility.

TABLE 9
Testing Procedure

| | |
|---|---|
| Number of Panelists | 29 |
| Sensory Questionnaire | Paired Comparison/intensity Ranking, |
| | Hedonic Acceptability, and Descriptive |
| | Analysis |
| Sample Codes | Random 3 digit |
| Test Design | Random order of presentation |
| Fatigue Minimization | Nestle water |
| Replicate Served | Yes |

The procedure of the taste and odor evaluations by the human sensory panel follow protocols suggested by ASTM and ISO and incorporates the scientific method and good statistical practices. Some of the standards that are used in the Sensory Science Lab are:
ASTM MNL 26 Sensory Testing Methods, STP 758 Guidelines for the Selection and Training of Sensory Panel Members
ASTM MNL 60 Physical Requirement Guidelines for Sensory Evaluation Laboratories, 2nd Edition
ASTM E 2609 Standard Test Method for Odor or Flavor Transfer or Both from Rigid Polymeric Packaging
ASTM E 1870 Standard Test Method for odor and Taste Transfer from Polymeric Packaging Films
ASTM E 2263 Paired Comparison Methodology
ISO 5495 Paired Comparison Methodology
ISO 8587 Ranking Methodology
ASTM DS 72 Aroma and Flavor Lexicon for Sensory Evaluation
ASTM MNL 13 Descriptive Analysis Testing for Sensory Evaluation
The 9-point Hedonic Scale; Dr. David R. Peryam

What is claimed:

1. A process for making a pouch having improved delamination property, said process comprising the following steps:
(I) providing a film structure,
wherein said film structure comprises a core layer comprising at least one biaxially-oriented hygroscopic polymer, and
wherein said film structure comprises, on at least one side adjacent said core layer, an adhesive layer comprising Pacacel™ adhesive; and
(II) preparing a pouch from said film structure provided in Step (I).

2. A process for making a pouch having improved pouch-drop performance, said process comprising the following steps:
(I) providing a film structure,
wherein said film structure comprises a core layer comprising at least one biaxially-oriented hygroscopic polymer, and
wherein said film structure comprises, on at least one side adjacent said core layer, an adhesive layer comprising Pacacel™ adhesive; and
(II) preparing a pouch from said film structure provided in Step (I).

3. A process, as recited in claim 1, wherein said step (II) comprises the following sub-steps:
(A) forming said film structure into a tubular member;
(B) heat-sealing the longitudinal edges of said tubular member;
(C) filling said tubular member with flowable material;
(D) heat-sealing a first transverse end of said tubular member to form a pouch; and
(E) sealing and cutting through a second transverse end of said tubular member to provide a filled pouch.

4. A process, as recited in claim 2, wherein said step (II) comprises the following sub-steps:
(A) forming said film structure into a tubular member;
(B) heat-sealing the longitudinal edges of said tubular member;
(C) filling said tubular member with flowable material;
(D) heat-sealing a first transverse end of said tubular member to form a pouch; and
(E) sealing and cutting through a second transverse end of said tubular member to provide a filled pouch.

5. A process, as recited in claim 1, wherein said at least one bi-axially oriented hygroscopic polymer comprises biaxially-oriented ethylene-vinyl alcohol copolymer or biaxially-oriented polyamide.

6. A process, as recited in claim 5, wherein said film structure comprises at least one skin layer, which is a monolayer or a co-extruded layer.

7. A process, as recited in claim 6, wherein said skin layer comprises a polymer blend comprising polyethylene or a polyethylene copolymer.

8. A process, as recited in claim 7, wherein said polymer blend comprises at least one of LLDPE, ULDPE, EVA, LDPE, HDPE, MDPE, and plastomer.

9. A process, as recited in claim 6, wherein said hygroscopic polymer is a biaxially-oriented polyamide, and said at least one skin layer comprises a co-extruded EVOH.

10. A pouch prepared by the process recited in claims 2.

11. A pouch for containing flowable material having improved delamination property and/or improved pouch-drop performance, made from a film structure;
wherein said film structure comprises a core layer comprising at least one biaxially-oriented hygroscopic polymer; and
wherein said film structure comprises, on at least one side adjacent said core layer, an adhesive layer comprising Pacacel™ adhesive.

12. A pouch, as recited in claim 11, wherein said at least one bi-axially oriented hygroscopic polymer comprises biaxially-oriented ethylene-vinyl alcohol copolymer or biaxially-oriented polyamide.

13. A pouch, as recited in claim 12, wherein said film structure comprises at least one skin layer, which is a monolayer or a co-extruded layer.

14. A pouch, as recited in claim 13, wherein said skin layer comprises a polymer blend comprising polyethylene or a polyethylene copolymer.

15. A pouch, as recited in claim 14, wherein said polymer blend comprises at least one of LLDPE, ULDPE, EVA, LDPE, HDPE, MDPE, and plastomer.

16. A pouch, as recited in claim 13, wherein said hygroscopic polymer is a biaxially-oriented polyamide, and said at least one skin layer comprises a co-extruded EVOH.

17. A pouch, as recited in claim 11, comprising flowable material.

18. A pouch, as recited in claim 11, wherein said pouch is an aseptic pouch; and/or an ESL pouch; and/or a hot-fill pouch; and/or a pasteurization pouch.

19. A bag for containing flowable material having improved delamination property and/or improved pouch-drop performance, made from a film structure;
wherein said film structure comprises a core layer comprising at least one biaxially-oriented hygroscopic polymer; and
wherein said film structure comprises, on at least one side adjacent said core layer, an adhesive layer comprising Pacacel™ adhesive.

20. A bag, as recited in claim 19, wherein said at least one bi-axially oriented hygroscopic polymer comprises biaxially-oriented ethylene-vinyl alcohol copolymer or biaxially-oriented polyamide.

21. A bag, as recited in claim 20, wherein said film structure comprises at least one skin layer, which is a monolayer or a co-extruded layer.

22. A bag, as recited in claim 21, wherein said skin layer comprises a polymer blend comprising polyethylene or a polyethylene copolymer.

23. A bag, as recited in claim 21, wherein said polymer blend comprises at least one of LLDPE, ULDPE, EVA, LDPE, HDPE, MDPE, and plastomer.

24. A bag, as recited in claim 23, wherein said hygroscopic polymer is a biaxially-oriented polyamide, and said at least one skin layer comprises a co-extruded EVOH.

25. A bag, as recited in claim 19, comprising flowable material.

26. A bag, as recited in claim 19, wherein said bag is an aseptic bag; and/or an ESL bag; and/or a hot-fill bag; and/or a pasteurization bag.
